(19) United States
(12) Patent Application Publication
(10) Pub. No.: US 2026/0225555 A1
(43) Pub. Date: Aug. 6, 2026

(54) SEAT BELT RETRACTOR AND METHOD OF PRODUCING THE SAME

(71) Applicant: ASHIMORI INDUSTRY CO., LTD., Osaka (JP)

(72) Inventors: Eri FUJIWARA, Osaka (JP); Daiki HIJIKATA, Osaka (JP)

(21) Appl. No.: 19/464,396

(22) Filed: Jan. 29, 2026

(30) Foreign Application Priority Data
Jan. 31, 2025 (JP) 2025-015521

(51) Int. Cl. B60R 22/34; B60R 22/36

(52) U.S. Cl. CPC B60R 22/3413; B60R 22/36

(57) ABSTRACT

A winding drum unit of a seat belt retractor includes a winding drum, a holding member, a locking base, an impact energy absorbing member, an impact energy absorbing wire, and a stopper member. Under a normal state, the impact energy absorbing member connects the winding drum and the locking base such that they are rotatable together. A head portion of the impact energy absorbing wire is attached to the holding member. The stopper member is screwed on to a male thread of a shaft portion of the locking base. The locking base is mountable to the holding member in a plurality of orientations defined by rotation about a rotational axis of the winding drum. A dimension of an inner contour of the holding member, as viewed in an axial direction of the winding drum, is greater than a dimension of an outer contour of the stopper member.

### CROSS-REFERENCE TO RELATED APPLICATION

This application claims priority to and the benefit of Japanese Patent Application No. 2025-015521, filed on January 31, 2025, the entire disclosure of which is incorporated herein by reference.

### BACKGROUND ART

### Field of the Invention

The present disclosure relates to a seat belt retractor capable of absorbing impact energy applied to a vehicle occupant in an emergency such as vehicle collision while allowing a webbing to be pulled out, and capable of restricting the pull-out amount of the webbing. The present disclosure also relates to a method of producing the seat belt retractor.

### Description of the Related Art

A seat belt retractor that prevents pull-out of a webbing in a vehicle emergency is conventionally known. In such a seat belt retractor, a winding drum on which the webbing is wound is rotatably mounted between a pair of side walls of a housing.

For example, Japanese Laid-Open Patent Application Publication No. 2024-127806 discloses a seat belt retractor capable of absorbing impact energy applied to a vehicle occupant in a vehicle emergency while allowing a webbing to be pulled out, and capable of restricting the pull-out amount of the webbing.

Specifically, the seat belt retractor of Japanese Laid-Open Patent Application Publication No. 2024-127806 includes, in addition to a housing and a winding drum, a torsion bar serving as an impact energy absorbing member, an impact energy absorbing wire, a stopper member, a locking base, and a pretensioner.

Under normal states, the torsion bar connects the winding drum and the locking base such that they are rotatable together. In a vehicle emergency, the torsion bar plastically deforms to absorb impact energy while permitting relative rotation between the winding drum and the locking base. In a vehicle emergency, the locking base is prevented from rotating in the pull-out direction.

A drive wheel of the pretensioner is mounted on the locking base. The impact energy absorbing wire is received in a slot of the winding drum, and a head portion of the impact energy absorbing wire is attached to the drive wheel. That is, the drive wheel functions as a holding member for the impact energy absorbing wire. During relative rotation between the winding drum and the locking base, the impact energy absorbing wire is pulled out from the opening of the slot while plastically deforming, thereby absorbing impact energy.

The drive wheel is annular. The locking base includes a main body portion located across the drive wheel from the winding drum, and a shaft portion extending from the main body portion, passing through, and protruding from the drive wheel. The shaft portion includes a male thread formed on the outer peripheral surface of its distal portion, and the stopper member is screwed on to the male thread.

The stopper member defines the allowable amount of relative rotation between the winding drum and the locking base during impact energy absorption by the torsion bar. In other words, the stopper member defines the pull-out amount of the webbing during impact energy absorption. Specifically, the stopper member is held in a central hole of the winding drum such that the stopper member is unable to rotate relative to the winding drum but is movable in the axial directions of the winding drum. The drive wheel includes a flange that projects radially inward and with which the stopper member can come into contact. During relative rotation between the winding drum and the locking base, the stopper member moves from an initial position to a position where it contacts the flange of the drive wheel, thereby limiting the relative rotation between the winding drum and the locking base to a predetermined amount.

The seat belt retractor of Japanese Laid-Open Patent Application Publication No. 2024-127806 is configured to finely adjust the pull-out amount of the webbing during impact energy absorption. To this end, the drive wheel includes six holding portions to which the head portion of the impact energy absorbing wire is attachable, and the holding portions are arranged at intervals of 60 degrees.

### SUMMARY OF THE INVENTION

In the seat belt retractor of Japanese Laid-Open Patent Application Publication No. 2024-127806, the drive wheel, which serves as a holding member for the impact energy absorbing wire, includes an inwardly projecting flange for contact with the stopper member. Accordingly, when assembling a winding drum unit including the winding drum, the torsion bar, the impact energy absorbing wire, the stopper member, the locking base, and the holding member, it is necessary first to prepare a subassembly composed of the holding member, the stopper member, and the impact energy absorbing wire that are set in the locking base, and then join the subassembly onto the winding drum. In this joining process, the torsion bar may be mounted to the locking base or the winding drum. In either case, joining the subassembly onto the winding drum requires mounting the stopper member and the torsion bar at their respective proper locations while concurrently placing the elongated impact energy absorbing wire into the slot of the winding drum. For this reason, assembly of the winding drum unit is difficult. It is therefore desirable to ease the work of assembling the winding drum unit.

An aspect of non-limiting embodiments of the present disclosure relates to providing: a seat belt retractor whose winding drum unit can be more easily assembled than those of conventional seat belt retractors; and a method of producing the seat belt retractor.

A first aspect of the present disclosure provides a seat belt retractor, the seat belt retractor including: a housing including a pair of opposed side walls; a winding drum on which a webbing is wound, the winding drum being located between the pair of side walls and rotatable in a winding direction for winding of the webbing and in a pull-out direction for pull-out of the webbing, the winding drum including a central hole opening at least in a first axial direction that is one of opposite axial directions of the winding drum; an annular holding member located in the first axial direction relative to the winding drum and rotatable relative to the winding drum; a locking base mounted on the holding member, rotatable together with the holding member, and configured to be prevented from rotating in the pull-out direction in a vehicle emergency, the locking base including a main body portion located across the holding member from the winding drum in the first axial direction, and a shaft portion projecting from the main body portion into an interior of the holding member and including a male thread on an outer peripheral surface of a portion located toward a distal end of the shaft portion, the shaft portion being coaxial with the winding drum; an impact energy absorbing member including a first end and a second end, coupled to the winding drum at or near the first end and to the locking base at or near the second end, and configured to, under a normal state, connect the winding drum and the locking base such that the winding drum and the locking base are rotatable together, the impact energy absorbing member being further configured to, in case that a pull-out force applied to the webbing exceeds a predetermined level while rotation of the locking base in the pull-out direction is prevented, plastically deform to absorb impact energy while permitting relative rotation between the winding drum and the locking base; an impact energy absorbing wire received in a slot located in the winding drum, the slot having an opening facing in the first axial direction, the impact energy absorbing wire including a head portion protruding from the opening of the slot and attached to the holding member, the impact energy absorbing wire being configured to, during relative rotation between the winding drum and the locking base, be pulled out from the opening of the slot while plastically deforming to absorb impact energy; and a stopper member held in the central hole, unable to rotate relative to the winding drum, movable in the first axial direction and in a second axial direction opposite to the first axial direction, and screwed on to the male thread of the locking base, the stopper member being configured to define an allowable amount of relative rotation between the winding drum and the locking base during impact energy absorption by the impact energy absorbing member, wherein the locking base is mountable to the holding member in a plurality of mounting positions that are orientations defined by rotation about a rotational axis of the winding drum, and a dimension of an inner contour of the holding member, as viewed in the first axial direction, is greater than a dimension of an outer contour of the stopper member.

A second aspect of the present disclosure provides a method of producing a seat belt retractor, the method including assembling a winding drum unit including a first subassembly and a second subassembly, wherein the first subassembly includes a winding drum, a holding member, and an impact energy absorbing wire, the second subassembly includes a locking base, a stopper member, and an impact energy absorbing member, and the assembling of the winding drum unit includes joining the second subassembly onto the first subassembly to couple the impact energy absorbing member to the winding drum and mount the locking base to the holding member.

A third aspect of the present disclosure provides a method of producing a seat belt retractor, the method including assembling a winding drum unit including a first subassembly and a second subassembly, wherein the first subassembly includes a winding drum, an impact energy absorbing member, a holding member, and an impact energy absorbing wire, the second subassembly includes a locking base and a stopper member, and the assembling of the winding drum unit includes joining the second subassembly onto the first subassembly to couple the impact energy absorbing member to the locking base and mount the locking base to the holding member.

### BRIEF DESCRIPTION OF THE DRAWINGS

FIG. 1 is a perspective view of a seat belt retractor according to one embodiment.

FIG. 2 is an exploded perspective view of the seat belt retractor shown in FIG. 1.

FIG. 3 is a cross-sectional view of the seat belt retractor shown in FIG. 1.

FIG. 4 is a cross-sectional view of a winding drum unit.

FIG. 5 is an exploded perspective view of some components of the winding drum unit.

FIG. 6 is an exploded perspective view of other components of the winding drum unit.

FIG. 7 is an exploded perspective view of further components of the winding drum unit and a synchronized gear.

FIG. 8 is a perspective view of a winding drum.

FIG. 9 is a perspective view of a bush.

FIG. 10 is a perspective view showing the winding drum, the bush, and a stopper member in cross-section to illustrate the winding drum with the bush, the stopper member, and an impact energy absorbing wire mounted thereon.

FIG. 11 is a perspective view of a holding member and a ring member.

FIG. 12 is an exploded perspective view of a locking base and a lock member.

FIG. 13 is an exploded perspective view of the locking base and the lock member as viewed in a direction opposite to that of FIG. 12.

FIG. 14 is a side view showing a return spring, with the lock member in a non-engagement position.

FIG. 15 is a side view showing the return spring, with the lock member in an engagement position.

FIG. 16 is a perspective view of a first subassembly and a second subassembly.

FIG. 17 is an exploded perspective view of the first subassembly.

FIG. 18 is a perspective view of a first subassembly and a second subassembly according to a modification.

### DETAILED DESCRIPTION

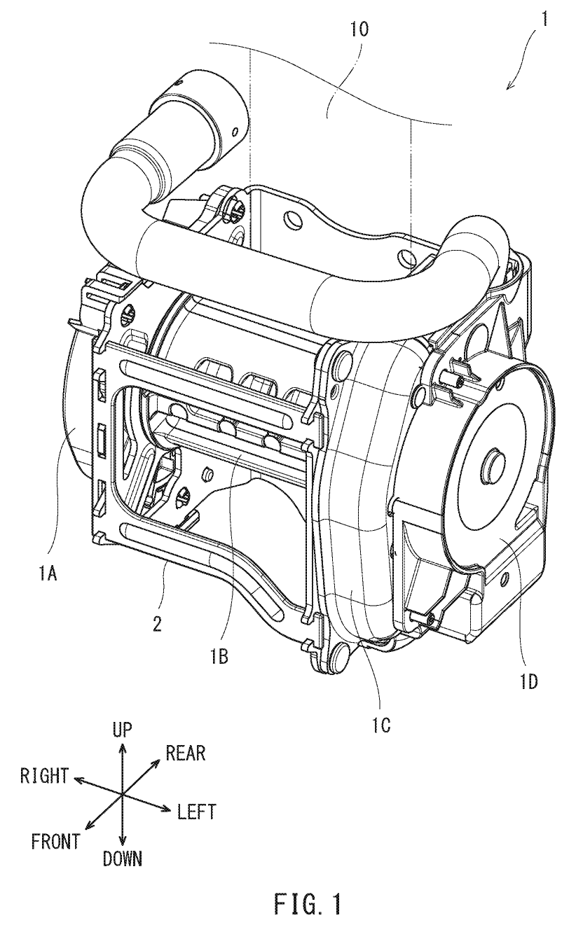

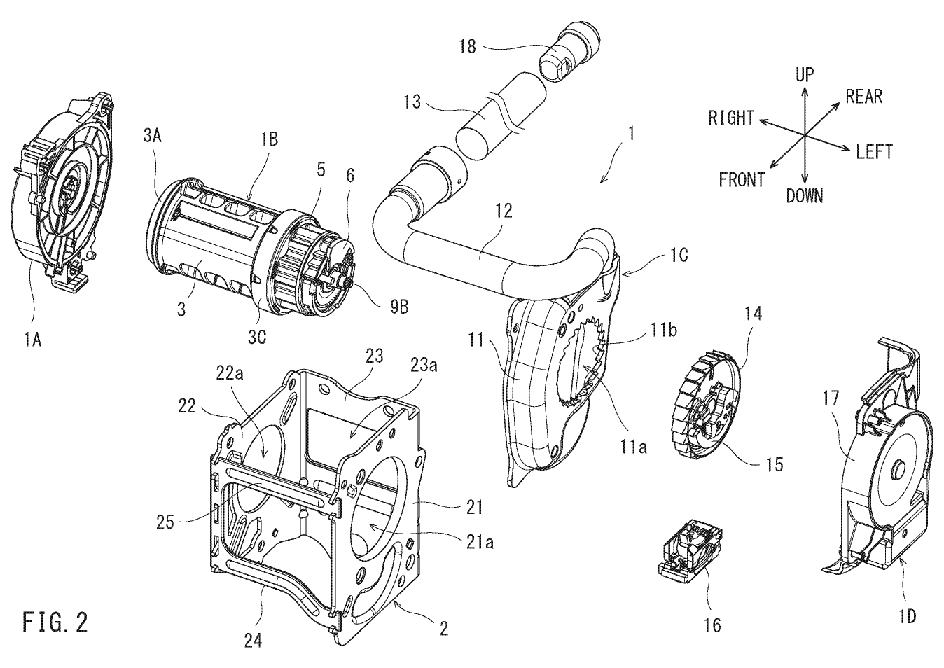

FIGS. 1 and 2 illustrate a seat belt retractor 1 according to one embodiment. The seat belt retractor 1 is a device capable of absorbing impact energy applied to a vehicle occupant in an emergency such as vehicle collision while allowing a webbing 10 serving as a seat belt to be pulled out, and capable of restricting the pull-out amount of the webbing 10.

Specifically, the seat belt retractor 1 includes a housing 2, a winding spring unit 1A, a winding drum unit 1B, a pretensioner 1C, and a lock unit 1D. The winding drum unit 1B includes a winding drum 3 on which the webbing 10 is wound. The housing 2 includes a first side wall 21 and a second side wall 22 that are opposed to each other in an axial direction of the winding drum 3.

The winding drum 3 is located between the first and second side walls 21 and 22 and is rotatable in a winding direction for winding of the webbing 10 and in a pull-out direction for pull-out of the webbing 10. The housing 2 includes a back plate 23 formed by sheet metal processing together with the first and second side walls 21 and 22 and extending perpendicular to the first and second side walls 21 and 22. The back plate 23 need not be formed by sheet metal processing together with the first and second side walls 21 and 22. The first and second side walls 21 and 22 formed separately from the back plate 23 may be mounted to the back plate 23.

Hereinafter, for convenience of description, the opposite directions along the axis of the winding drum 3 will be referred to as the leftward and rightward directions, and the opposite directions along the thickness of the back plate 23 will be referred to as the forward and rearward directions. The direction from the second side wall 22 toward the first side wall 21 is the leftward direction, and the direction from the first side wall 21 toward the second side wall 22 is the rightward direction. The direction from the back plate 23 toward the side walls 21 and 22 is the forward direction, and the opposite direction is the rearward direction. The leftward direction is an example of a first axial direction, and the rightward direction is an example of a second axial direction. As illustrated in FIGS. 1 and 2, one of the opposite directions orthogonal to the leftward and rightward directions and the forward and rearward directions will be referred to as the upward direction, and the other opposite direction will be referred to as the downward direction.

Lower portions of the front sides of the first and second side walls 21 and 22 of the housing 2 are connected to each other by a connecting bar 24, and upper portions of the front sides of the first and second side walls 21 and 22 are connected to each other by a connecting bar 25. The first and second side walls 21 and 22 respectively include openings 21a and 22a through which the winding drum 3 is inserted into the housing 2. The back plate 23 includes an opening 23a through which the winding drum 3 is exposed outside the housing 2.

The winding spring unit 1A is mounted on the second side wall 22 of the housing 2, and the pretensioner 1C is mounted on the first side wall 21 of the housing 2. The lock unit 1D is mounted on the pretensioner 1C.

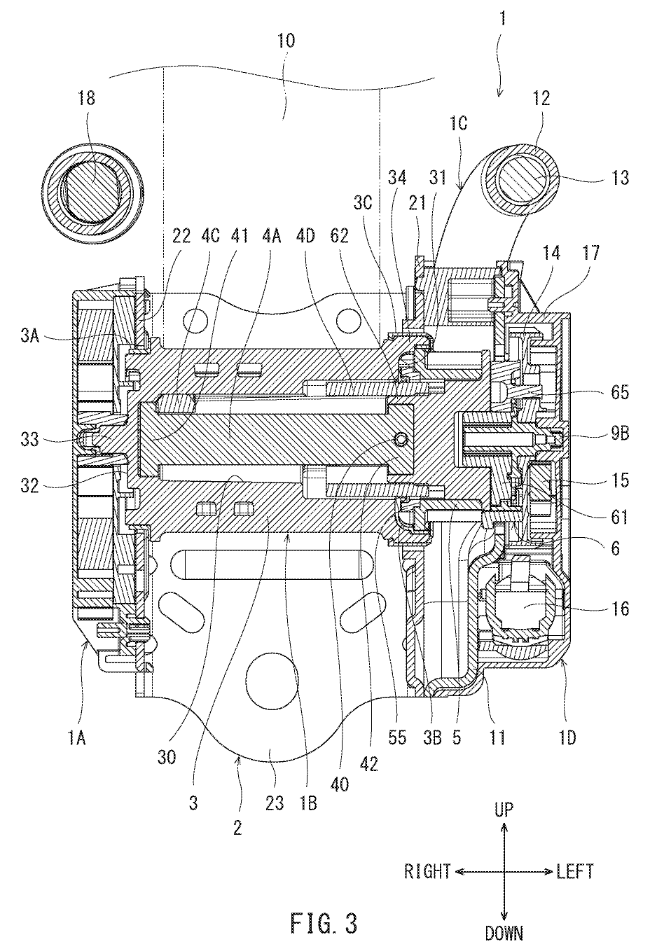

As illustrated in FIG. 3, the winding drum 3 includes a first end surface 31 adjacent to the first side wall 21 of the housing 2 and a second end surface 32 adjacent to the second side wall 22 of the housing 2. In the present embodiment, the winding drum 3 includes a shaft portion 33 projecting rightward from the second end surface 32, and the shaft portion 33 is rotatably supported by the winding spring unit 1A. Alternatively, a torsion bar described later, which serves as an impact energy absorbing member 4A, may extend through the winding drum 3, and the right end of the torsion bar may be rotatably supported by the winding spring unit 1A. The configuration of the winding spring unit 1A is well known and will therefore not be described in detail.

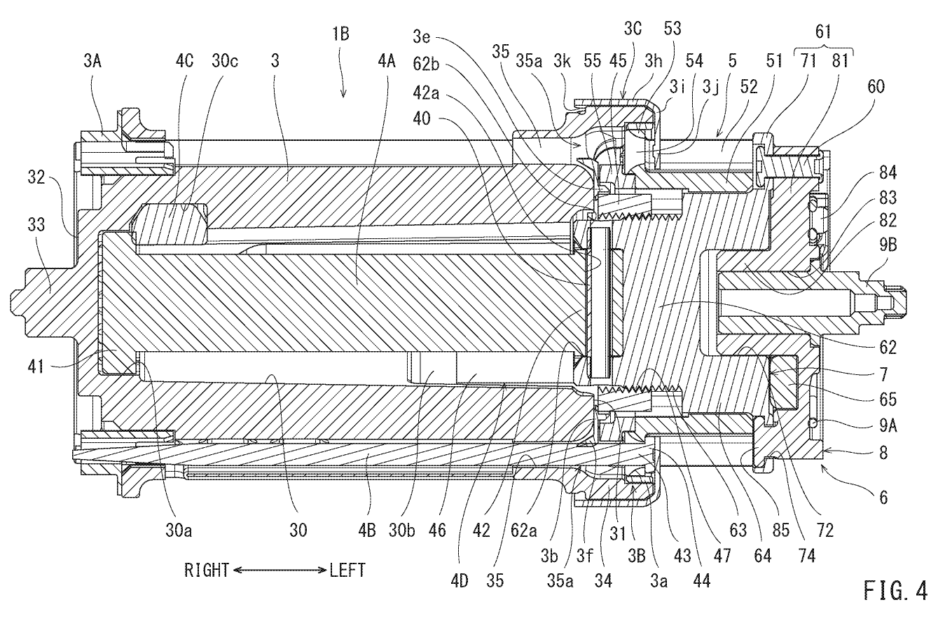

As illustrated in FIGS. 4 to 7, the winding drum unit 1B includes, in addition to the winding drum 3, bushes 3A and 3B, an impact energy absorbing member 4A, a clip 4C, an impact energy absorbing wire 4B, a ring member 55, a holding member 5, a stopper member 4D, a bearing 3C, a locking base 6, a return spring 9A, and a rotation shaft 9B. In the present embodiment, the holding member 5 also functions as a drive wheel of the pretensioner 1C.

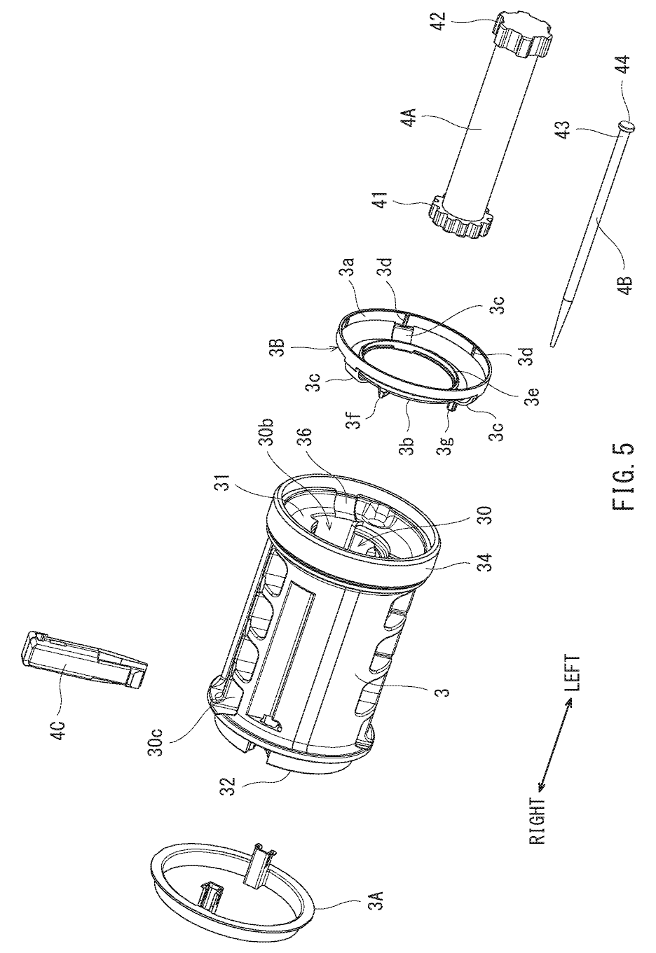

As illustrated in FIGS. 3 and 5, the bush 3A is annular and mounted on the right end of the winding drum 3 which is located in the opening 22a of the second side wall 22. The left end of the winding drum 3 includes a tubular rib 34 protruding from the edge of the first end surface 31 and located in the opening 21a of the first side wall 21. The bearing 3C is annular and mounted on the left end of the winding drum 3 to cover the outer peripheral surface of the rib 34. The bush 3A and the bearing 3C serve as emergency means for enabling the winding drum 3 to rotate smoothly even when the winding drum 3 is displaced relative to the housing 2 in a vehicle emergency.

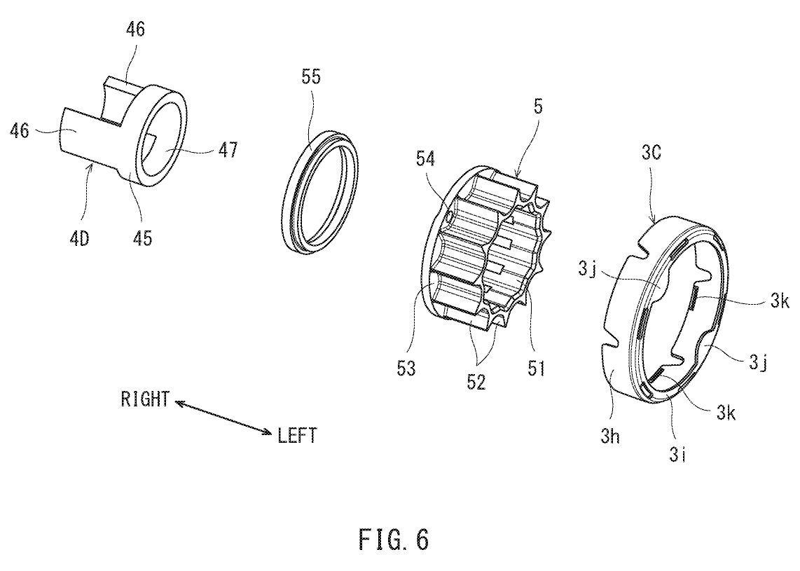

To be more specific, as illustrated in FIGS. 4 and 6, the bearing 3C includes a tubular portion 3h covering the outer peripheral surface of the rib 34 and a ring portion 3i covering the end surface of the rib 34. The bearing 3C further includes two cover portions 3j projecting radially inward from the ring portion 3i. One of the cover portions 3j covers a retainer portion 44 described later, which is a part of the impact energy absorbing wire 4B.

The right end of the inner peripheral surface of the tubular portion 3h includes a plurality of engagement claws 3k. The right end of the rib 34 includes stepped portions as engagement portions for engaging with the engagement claws 3k. The bearing 3C is fitted onto the left end of the winding drum 3 by engagement of the engagement claws 3k with the stepped portions. One of the cover portions 3j contacts the retainer portion 44. Accordingly, rattling of a head portion 43 (described later) of the impact energy absorbing wire 4B can be prevented.

As illustrated in FIGS. 4 and 5, the bush 3B is mounted on the left end of the winding drum 3 to cover a portion of the inner peripheral surface of the rib 34, which is closer to the distal end of the rib 34 than the proximal end of the rib 34, and a portion of the first end surface 31, which is closer to the center of the first end surface 31 than the outer edge of the first end surface 31. When the winding drum 3 rotates relative to the locking base 6, the bush 3B slides relative to the holding member 5 and the ring member 55.

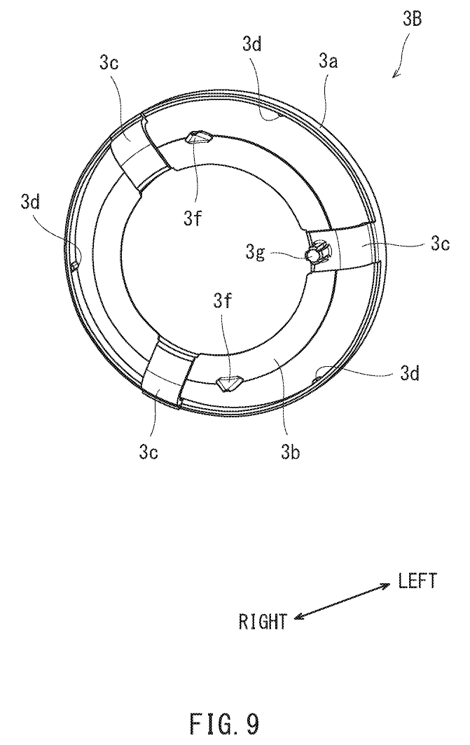

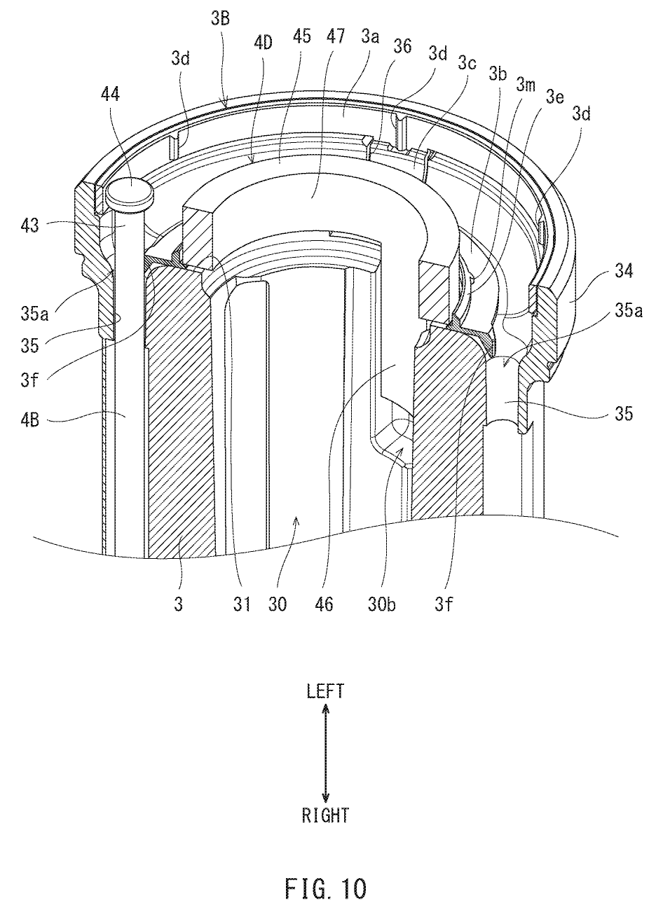

To be more specific, as illustrated in FIGS. 9 and 10, the bush 3B includes: a wall portion 3a that contacts the inner peripheral surface of the rib 34 of the winding drum 3; a ring portion 3b that contacts the first end surface 31 of the winding drum 3; and a plurality of connection portions 3c connecting the wall portion 3a to the ring portion 3b. In the illustrated example, the number of the connection portions 3c is three, although this number is not limiting.

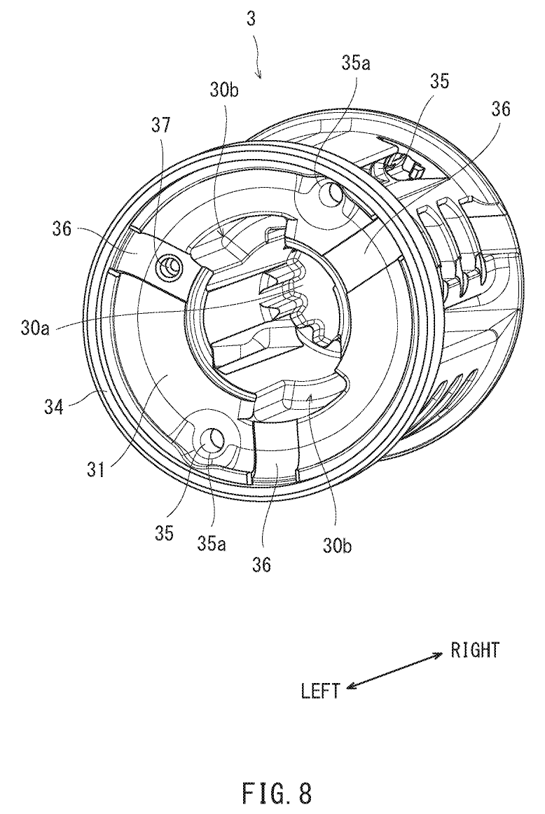

As illustrated in FIG. 8, the left end of the winding drum 3 includes a plurality of holding grooves 36 into which the connection portions 3c of the bush 3B are fitted. Each holding groove 36 extends over a proximal portion of the inner peripheral surface of the rib 34, which is closer to the proximal end of the rib 34 than the distal end of the rib 34, and the first end surface 31. In the illustrated example, the number of the holding grooves 36 is three, although this number is not limiting. Furthermore, one of the holding grooves 36 includes an insertion hole 37 into which a boss 3g located on one of the connection portions 3c is inserted.

When the ring member 55 and the holding member 5 have been mounted on the winding drum 3, the wall portion 3a is located between the outer peripheral surface of a flange portion 53 (described later) of the holding member 5 and the inner peripheral surface of the rib 34, and the ring portion 3b is located between the first end surface 31 of the winding drum 3 and the right end surface of the ring member 55. The inner peripheral surface of the wall portion 3a includes a plurality of protrusions 3d for preventing rattling of the holding member 5 and improving the sliding properties of the holding member 5.

When the stopper member 4D has been mounted on the winding drum 3, the ring portion 3b serves to prevent rattling of the stopper member 4D. Specifically, the inner peripheral surface of the ring portion 3b contacts the outer peripheral surfaces of claw portions 46 (described later) of the stopper member 4D.

As illustrated in FIGS. 5 and 10, there is a tubular rib 3e near the inner edge of the ring portion 3b, and the rib 3e protrudes leftward from the ring portion 3b. The rib 3e is located between the outer peripheral surface of an annular portion 45 (described later) of the stopper member 4D and the inner peripheral surface of the ring member 55. The outer peripheral surface of the rib 3e includes a plurality of protrusions 3m for preventing rattling of the ring member 55 and improving the sliding properties of the ring member 55.

A biasing piece 3f projects from the outer edge of the ring portion 3b. The biasing piece 3f enters an opening 35a of a slot 35 described later to bias the impact energy absorbing wire 4B outward in the radial direction of the winding drum 3. As a result, rattling of the impact energy absorbing wire 4B in the slot 35 can be prevented.

The bushes 3A and 3B and the bearing 3C are made of a material having better sliding properties with respect to metals than sliding between metals. Examples of such materials include fluororesin, polyacetal, and polypropylene.

The winding drum 3 includes a central hole 30 extending along the central axis of the winding drum 3. In the present embodiment, the central hole 30 is a bottomed hole that opens only leftward. Alternatively, when, as mentioned above, the torsion bar serving as the impact energy absorbing member 4A extends through the winding drum 3, the central hole 30 may open both leftward and rightward.

The ring member 55 and the holding member 5 are located to the left of the winding drum 3 and are rotatable relative to the winding drum 3 due to the bush 3B. The ring member 55 and the holding member 5 form an annular shape extending along the periphery of the central hole 30 of the winding drum 3 and facing the first end surface 31.

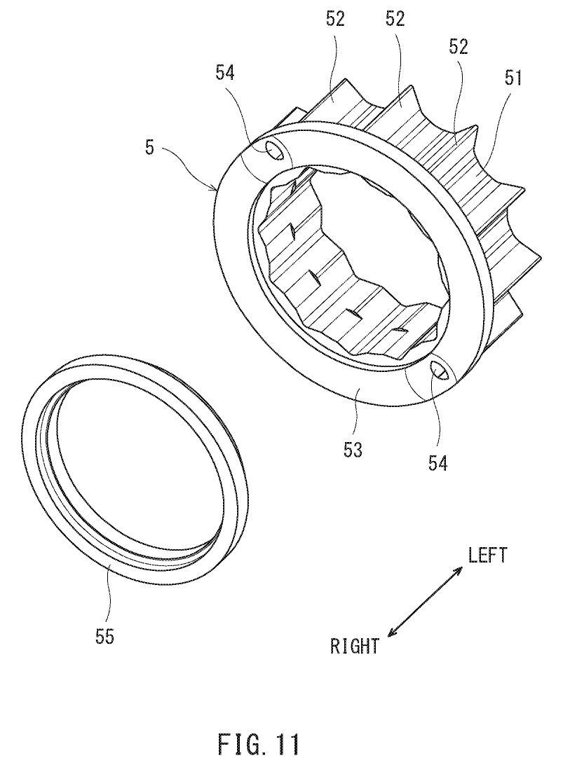

As illustrated in FIG. 11, the holding member 5 includes a tubular main body portion 51, a plurality of engagement teeth 52 formed on the outer peripheral surface of the main body portion 51, and an annular flange portion 53 located to the right of the engagement teeth 52 and projecting radially outward from the main body portion 51. The inner edge of the right surface of the flange portion 53 includes a recess, into which the left end of the ring member 55 is inserted. Thus, the ring member 55 is rotatable relative to the holding member 5.

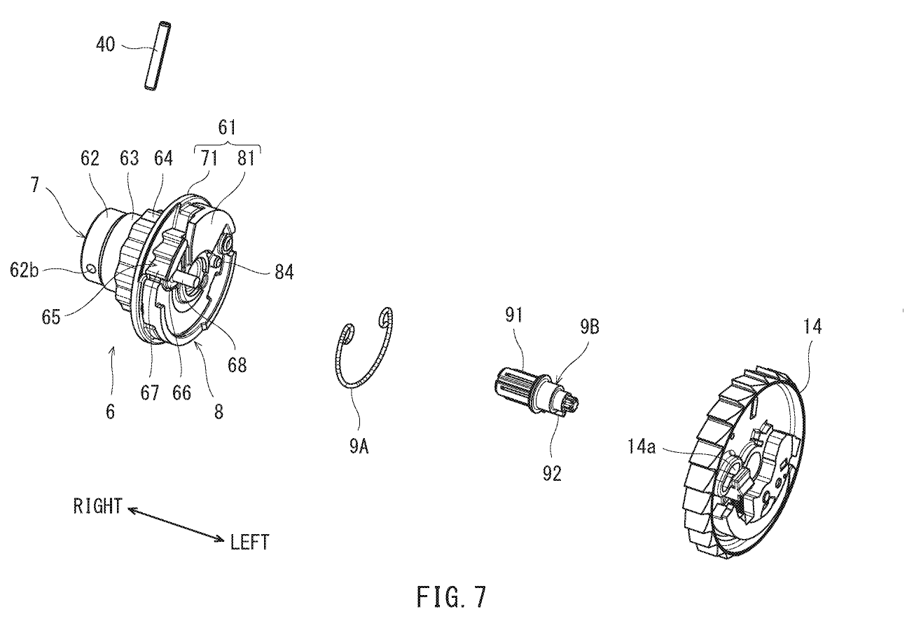

As illustrated in FIGS. 4 and 7, the locking base 6 mentioned above is mounted on, and rotatable together with, the holding member 5. The locking base 6 includes: a main body portion 61 located to the left of the holding member 5 and across the holding member 5 from the winding drum 3 in the axial direction of the winding drum 3; and a shaft portion 62 projecting from the main body portion 61 into an internal space defined by the holding member 5 and the ring member 55, the shaft portion 62 being coaxial with the winding drum 3.

The shaft portion 62 includes a male thread 63 formed on the outer peripheral surface of a portion located toward the distal end of the shaft portion 62, in the other words, a portion located closer to the distal end of the shaft portion 62 than the proximal end of the shaft portion 62. In the present embodiment, the shaft portion 62 includes a small-diameter distal portion, a middle portion having a slightly larger diameter than the distal portion and including the male thread 63, and a proximal portion 64 protruding radially outward beyond the male thread 63 at a portion of the shaft portion 62 from the male thread 63 toward the main body portion 61 of the locking base 6.

The locking base 6 is mountable to the holding member 5 in a plurality of mounting positions that are orientations defined by rotation about the rotational axis of the winding drum 3. To this end, the outer peripheral surface of the proximal portion 64 of the shaft portion 62 includes a plurality of engagement projections arranged at equal angular intervals, and the inner peripheral surface of the main body portion 51 of the holding member 5 includes engagement depressions that mesh with the engagement projections. In the illustrated example, the number of the engagement projections is 12, although this number is not limiting. The outer peripheral surface of the proximal portion 64 and the inner peripheral surface of the main body portion 51 may have a regular polygonal cross-section.

As illustrated in FIGS. 4 and 5, the torsion bar serving as the impact energy absorbing member 4A is inserted into the central hole 30 of the winding drum 3. One end portion of the torsion bar remote from the locking base 6 is coupled to the winding drum 3 and is unable to rotate relative to the winding drum 3, and the other end portion of the torsion bar is coupled to the locking base 6 and is unable to rotate relative to the locking base 6. The one end portion of the torsion bar is an example of a first end, and the other end portion of the torsion bar is an example of a second end.

To be more specific, the one end portion of the torsion bar serving as the impact energy absorbing member 4A includes a splined coupling portion 41, and the other end portion includes a splined coupling portion 42. The bottom of the central hole 30 of the winding drum 3 includes a splined recess 30a for coupling with the coupling portion 41, and the coupling portion 41 is fitted into the recess 30a. The distal end surface of the shaft portion 62 of the locking base 6 includes a splined recess 62a for coupling with the coupling portion 42, and the coupling portion 42 is fitted into the recess 62a.

In the present embodiment, the coupling portion 41 is configured to be fitted into the recess 30a in a plurality of fitting positions that are orientations defined by rotation about the rotational axis of the winding drum 3. The number of the fitting positions is equal to the number of the above-described mounting positions that the locking base 6 can assume when mounted to the holding member 5. With the coupling portion 41 fitted in the recess 30a, the clip 4C is inserted into the central hole 30 through an insertion hole 30c extending from the outer peripheral surface of the winding drum 3 to the central hole 30, and a portion of the clip 4C is positioned in contact with the left side of the coupling portion 41 in the central hole 30. This allows the torsion bar serving as the impact energy absorbing member 4A and the winding drum 3 to remain coupled together.

In the present embodiment, the distal portion of the shaft portion 62 of the locking base 6 includes a through hole 62b, and the coupling portion 42 includes a through hole 42a. The through holes 62b and 42a extend perpendicular to the axial direction of the winding drum 3, and a spring pin 40 is inserted into the through holes 62b and 42a. This allows the torsion bar serving as the impact energy absorbing member 4A and the locking base 6 to remain coupled together.

Under normal states, the torsion bar serving as the impact energy absorbing member 4A connects the winding drum 3 and the locking base 6 such that they are rotatable together. In case that a pull-out force applied to the webbing 10 exceeds a predetermined level while the rotation of the locking base 6 in the pull-out direction is prevented, the torsion bar plastically deforms to absorb impact energy while permitting relative rotation between the winding drum 3 and the locking base 6.

The impact energy absorbing wire 4B absorbs impact energy during an initial phase of relative rotation between the winding drum 3 and the locking base 6. In the present embodiment, as illustrated in FIG. 8, the winding drum 3 includes two slots 35 spaced at an interval of 180 degrees. In the present embodiment, the slots 35 open both leftward and rightward. Alternatively, the slots 35 may open only leftward. In the present embodiment, each slot 35 is shaped as a groove the entirety of which, excluding both ends, is recessed obliquely from the outer peripheral surface of the winding drum 3. Alternatively, the entirety of each slot 35 may be a hole extending in the axial direction of the winding drum 3. There may be only a single slot 35.

As illustrated in FIG. 4, the impact energy absorbing wire 4B is received in one of the slots 35, with its head portion 43 protruding from an opening 35a of the slot 35. During relative rotation between the winding drum 3 and the locking base 6, the impact energy absorbing wire 4B is pulled out from the opening 35a while plastically deforming to absorb impact energy. When pulled out from the opening 35a of the slot 35, the impact energy absorbing wire 4B is wound on the ring member 55.

As illustrated in FIGS. 4 and 11, the flange portion 53 of the holding member 5 includes two holding holes 54 spaced at an interval of 180 degrees. The head portion 43 of the impact energy absorbing wire 4B is attached to one of the holding holes 54. The head portion 43 of the impact energy absorbing wire 4B includes a retainer portion 44 having a larger diameter than the holding holes 54.

The stopper member 4D defines the allowable amount of relative rotation between the winding drum 3 and the locking base 6 during impact energy absorption by the impact energy absorbing member 4A. The stopper member 4D is held in the central hole 30 of the winding drum 3, and is unable to rotate relative to the winding drum 3 but is movable in the leftward and rightward directions.

As illustrated in FIGS. 4 and 6, the stopper member 4D has the shape of a tube, into which the torsion bar serving as the impact energy absorbing member 4A is inserted. The inner peripheral surface of the stopper member 4D includes a female thread 47 screwed on to the male thread 63 of the shaft portion 62 of the locking base 6.

In the present embodiment, the stopper member 4D includes an annular portion 45 and two claw portions 46 projecting rightward from the annular portion 45, the two claw portions 46 being spaced at an interval of 180 degrees. The central hole 30 of the winding drum 3 includes two guide grooves 30b spaced at an interval of 180 degrees. That is, the stopper member 4D is insertable into the central hole 30 in a plurality of mounting positions that are orientations defined by rotation defined at predetermined angular intervals. In the present embodiment, the angular interval between the mounting positions of the stopper member 4D is 180 degrees, although this value is not limiting. The locking base 6 is mountable to the holding member 5 in a plurality of mounting positions that are orientations defined by rotation at angular intervals smaller than the predetermined angular intervals. In the present embodiment, the angular interval between the mounting positions of the locking base 6 is 30 degrees, although this value is not limiting.

The two claw portions 46 are fitted, respectively, into the two guide grooves 30b, so that the stopper member 4D is held in the central hole 30 of the winding drum 3, and is unable to rotate relative to the winding drum 3 but is movable in the leftward and rightward directions. The stopper member 4D need not include the claw portions 46; alternatively, the profile of the stopper member 4D and the left end of the central hole 30 of the winding drum 3 may be polygonal in cross-section.

In the present embodiment, as illustrated in FIGS. 3 and 4, during relative rotation between the winding drum 3 and the locking base 6, the stopper member 4D moves from an initial position, where the stopper member 4D is spaced apart from the proximal portion 64 of the shaft portion 62, to a position where the stopper member 4D contacts the proximal portion 64. As a result, the relative rotation between the winding drum 3 and the locking base 6 is limited to a predetermined amount.

In other words, the stopper member 4D comes into contact with the proximal portion 64, thereby being prevented from moving further in the axial direction of the winding drum 3. The stopper member 4D contacts the proximal portion 64 in the interior of the holding member 5. In the present embodiment, the contact of the stopper member 4D with the proximal portion 64 occurs within a region where the engagement teeth 52 of the holding member 5 exist in the axial direction of the winding drum 3.

In the present embodiment, each of the dimensions of the inner contours of the holding member 5 and the ring member 55, as viewed in the axial direction of the winding drum 3, is greater than the dimension of the outer contour of the stopper member 4D. Accordingly, the stopper member 4D can pass through the interiors of the holding member 5 and the ring member 55.

In a vehicle emergency, the pretensioner 1C rotates the holding member 5, thereby rotating the winding drum 3 in the winding direction via the locking base 6 and the impact energy absorbing member 4A. As illustrated in FIGS. 2 and 3, the pretensioner 1C includes a pretensioner casing 11 mounted on the first side wall 21 of the housing 2, a bent pipe 12 extending from the pretensioner casing 11, a movable member 13 located within the pipe 12, and a gas generator 18 located within the distal end of the pipe 12.

The movable member 13 moves during operation of the pretensioner 1C. For example, the movable member 13 is an elongate rod-shaped member made of resin, and plastically deforms as the engagement teeth 52 of the holding member 5 bite into it. Alternatively, the movable member 13 may be constituted by separate segments arranged at intervals equal to the pitch of the engagement teeth 52 of the holding member 5. The separate segments are, for example, but not limited to, spherical objects. In a vehicle emergency, the movable member 13 is pushed out of the pipe 12 by the gas generated by the gas generator 18 and engages with the engagement teeth 52 of the holding member 5, thereby rotating the holding member 5 in the winding direction. In conjunction with the rotation of the holding member 5, the locking base 6, the impact energy absorbing member 4A, and the winding drum 3 also rotate. After the pretensioner 1C is actuated, the pressure of the gas in the pipe 12 blocks the movable member 13 from being pushed back into the pipe 12. Consequently, the rotation of the holding member 5 in the pull-out direction is prevented.

As illustrated in FIGS. 2 and 3, the pretensioner casing 11 includes an opening 11a into which the locking base 6 is inserted, and inner teeth 11b are formed on the edge of the opening 11a. The locking base 6 includes a lock member 65 engageable with the inner teeth 11b. In a vehicle emergency, the lock member 65 engages with the inner teeth 11b to prevent the rotation of the locking base 6 in the pull-out direction.

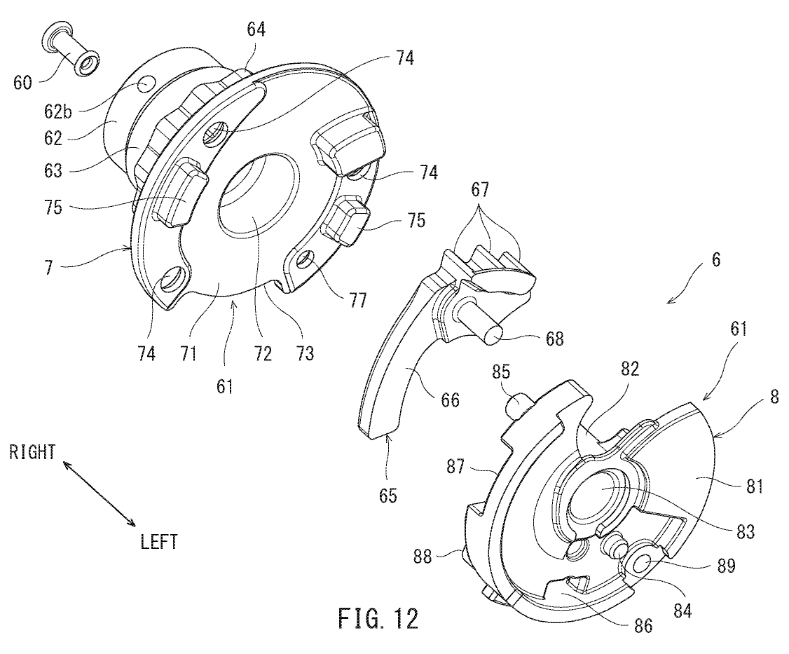

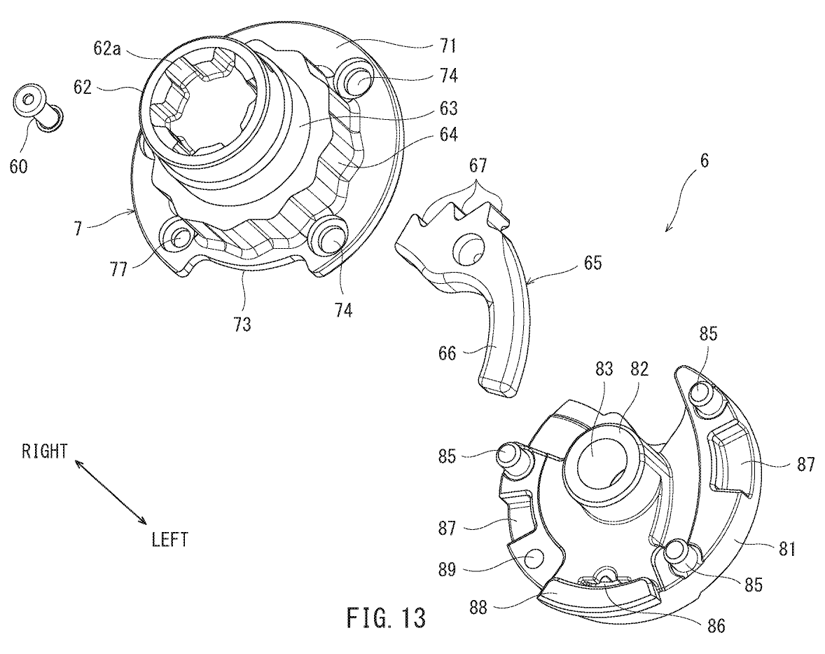

As illustrated in FIGS. 12 and 13, the locking base 6 includes a first base member 7 including the right side of the main body portion 61 and the shaft portion 62, and a second base member 8 including the left side of the main body portion 61. The lock member 65 is held between the first and second base members 7 and 8.

To be more specific, the first base member 7 includes a first main body portion 71, and the second base member 8 includes a second main body portion 81. The first and second main body portions 71 and 81 are generally shaped as discs that are fitted on each other. These portions 71 and 81 constitute the main body portion 61 of the locking base 6.

The first main body portion 71 includes a recess 72 at the center of its left surface, and a fitting protrusion 82 that fits into the recess 72 is located at the center of the right surface of the second main body portion 81. The first main body portion 71 includes a cut 73 at its edge, and an engagement projection 88 that engages with the cut 73 is located at the edge of the second main body portion 81. Furthermore, the second main body portion 81 includes two engagement depressions 87 at the edge of its right surface, and two engagement projections 75 that engage with the engagement depressions 87 are located at the edge of the left surface of the first main body portion 71.

In the present embodiment, the second main body portion 81 includes three crimping protrusions 85 on its right surface, and the first main body portion 71 includes three through holes 74 into which the crimping protrusions 85 are inserted. The portions of the crimping protrusions 85 that protrude from the through holes 74 are crimped to connect the first and second base members 7 and 8 together. FIGS. 12 and 13 show the crimping protrusions 85 that have not yet been crimped. The number of the crimping protrusions 85 and the number of the through holes 74 need not be three, and may be one, two, or four or more.

Furthermore, in the present embodiment, a rivet 60 is also used for connection between the first and second base members 7 and 8. To this end, the first and second main body portions 71 and 81 include, respectively, through holes 77 and 89 for the rivet 60.

The second base member 8 includes a through hole 83 located at the center of, and extending through, the second base member 8. The second base member 8 further includes a pin 84 projecting leftward from the left surface of the second main body portion 81.

The lock member 65 includes: a main body portion 66 having the form of a generally arc-shaped plate and held by the first main body portion 71 of the first base member 7 and the second main body portion 81 of the second base member 8; a plurality of engagement teeth 67 formed on the outer side surface of the main body portion 66 and engageable with the inner teeth 11b described above; and an operation shaft 68 projecting leftward from the main body portion 66. In the illustrated example, the number of the engagement teeth 67 is three, although this number is not limiting.

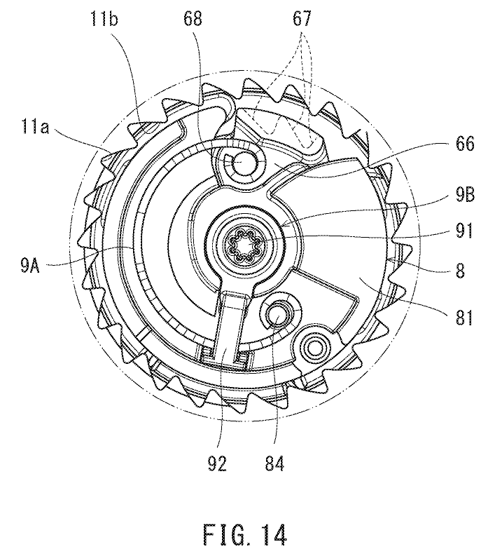

The return spring 9A mentioned above is generally arc-shaped as shown in FIG. 7. One end of the return spring 9A engages with the operation shaft 68 of the lock member 65, and the other end engages with the pin 84 of the locking base 6. The return spring 9A serves to retain the lock member 65 in a non-engagement position shown in FIG. 14.

The lock member 65 is operated by a synchronized gear 14 shown in FIGS. 2 and 7. As illustrated in FIG. 2, the lock unit 1D includes a cover member 17 enclosing the synchronized gear 14 and a vehicle sensor 16. The synchronized gear 14 is equipped with a webbing sensor 15. The webbing sensor 15 is activated in response to rapid pull-out of the webbing 10, thereby preventing the rotation of the synchronized gear 14 in the pull-out direction. The vehicle sensor 16 is activated in response to a significant change in vehicle acceleration, thereby preventing the rotation of the synchronized gear 14 in the pull-out direction.

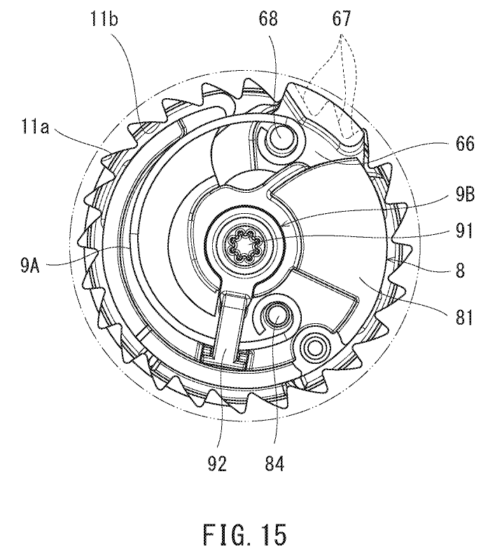

Once the rotation of the synchronized gear 14 in the pull-out direction is prevented, the locking base 6 rotates together with the winding drum 3 relative to the synchronized gear 14, and the operation shaft 68 of the lock member 65 is operated by a guide hole 14a of the synchronized gear 14 which is shown in FIG. 7. As a result, the lock member 65 moves from the non-engagement position shown in FIG. 14 to an engagement position shown in FIG. 15.

As illustrated in FIGS. 7 and 12, the rotation shaft 9B mentioned above includes a rod-shaped main body portion 91 and an arm 92 extending radially outward from the main body portion 91. The right portion of the main body portion 91 is fitted into the through hole 83 of the second base member 8. The arm 92 serves to hold the return spring 9A in position. A hook at the distal end of the arm 92 engages with an engagement hole 86 of the second main body portion 81 of the second base member 8 of the locking base 6.

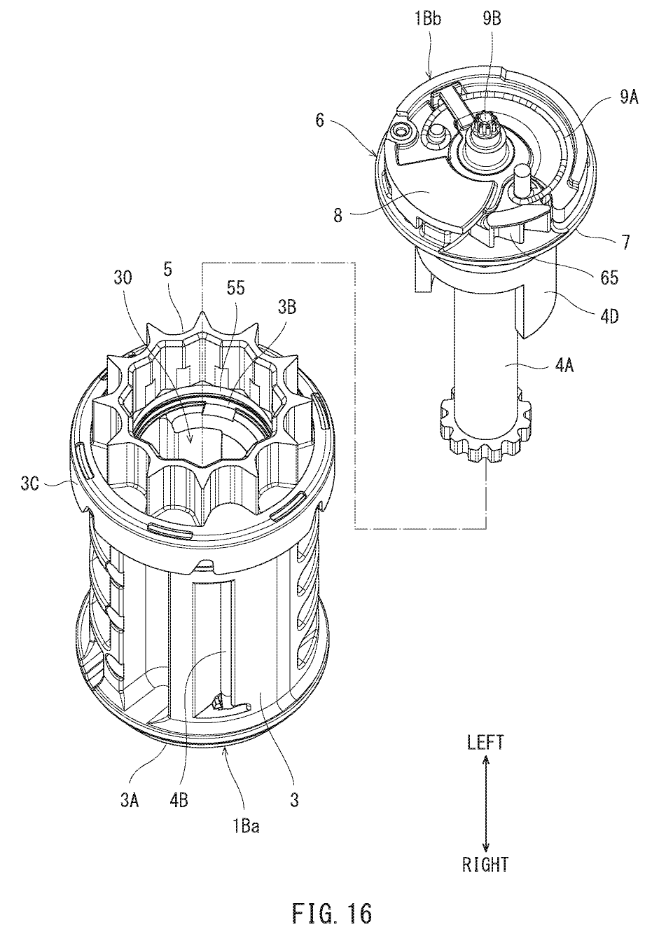

Hereinafter, the step of assembling the winding drum unit 1B, which is one of the steps of the method of producing the seat belt retractor 1, will be described with reference to FIG. 16. As seen from FIG. 2, the seat belt retractor 1 is produced by first assembling the winding drum unit 1B, then inserting the winding drum unit 1B into the openings 21a and 22a of the housing 2, subsequently mounting the pretensioner 1C to the housing 2 with the inserted winding drum unit 1B, then mounting the lock unit 1D to the pretensioner 1C, and further mounting the winding spring unit 1A to the housing 2.

As seen from FIG. 16, the following subassemblies are prepared first: a first subassembly 1Ba including the winding drum 3, the bushes 3A and 3B, the ring member 55, the holding member 5, the bearing 3C, and the impact energy absorbing wire 4B; and a second subassembly 1Bb including the locking base 6, the lock member 65, the return spring 9A, the rotation shaft 9B, the stopper member 4D, and the torsion bar serving as the impact energy absorbing member 4A.

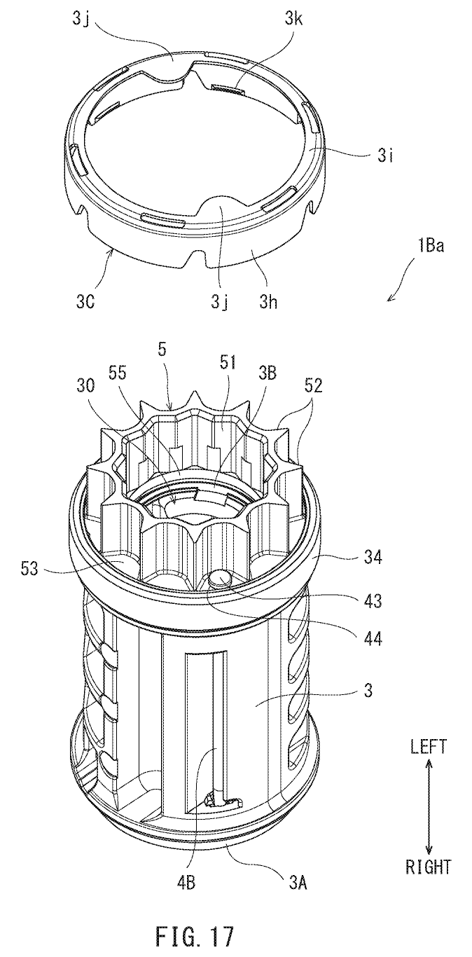

As illustrated in FIG. 17, in the first subassembly 1Ba, the bearing 3C, which is an annular member mounted on the left end of the winding drum 3, retains the holding member 5 on the winding drum 3. Since the holding member 5 is retained on the winding drum 3 by the bearing 3C, the first subassembly 1Ba is easy to handle. As illustrated in FIG. 16, in the second subassembly 1Bb, the spring pin 40 shown in FIG. 4 allows the torsion bar serving as the impact energy absorbing member 4A to remain coupled to the locking base 6.

The second subassembly 1Bb is then joined onto the first subassembly 1Ba. Thus, the torsion bar is coupled to the winding drum 3, and the locking base 6 is mounted to the holding member 5.

In the seat belt retractor 1 of the present embodiment, the dimension of the inner contour of the holding member 5 is greater than the dimension of the outer contour of the stopper member 4D. Accordingly, after the holding member 5 has been mounted on the winding drum 3, the stopper member 4D can be inserted into the central hole 30 in a direction from the holding member 5 toward the winding drum 3. That is, the second subassembly 1Bb including the locking base 6 and the stopper member 4D can be joined onto the first subassembly 1Ba including the winding drum 3, the holding member 5, and the impact energy absorbing wire 4B. In other words, when joining a subassembly onto the winding drum 3, it is unnecessary to, as in the case of conventional seat belt retractors, mount the stopper member 4D and the torsion bar serving as the impact energy absorbing member 4A at their respective proper locations in the central hole 30 of the winding drum 3 while concurrently placing the elongated impact energy absorbing wire 4B into the slot 35. The impact energy absorbing wire 4B can be placed in the slot 35 of the winding drum 3 before the second subassembly 1Bb is joined onto the first subassembly 1Ba, and joining the second subassembly 1Bb onto the first subassembly 1Ba can be accomplished simply by mounting the stopper member 4D and the torsion bar serving as the impact energy absorbing member 4A at their respective proper locations in the central hole 30 of the winding drum 3. Accordingly, the winding drum unit 1B can be assembled more easily than conventional winding drum units.

In addition, the locking base 6 is mountable to the holding member 5 in a plurality of mounting positions that are orientations defined by rotation about the rotational axis of the winding drum 3. Accordingly, the pull-out amount of the webbing 10 during impact energy absorption can be finely adjusted by changing the mounting position of the locking base 6 on the holding member 5.

Furthermore, in the present embodiment, the pull-out amount of the webbing 10 during impact energy absorption can be adjusted at large angular intervals by changing the mounting position of the stopper member 4D on the winding drum 3, and can be adjusted at small angular intervals by changing the mounting position of the locking base 6 on the holding member 5. Since it is unnecessary to provide a large number of mounting positions for the stopper member 4D on the winding drum 3, sufficient mounting strength between the winding drum 3 and the stopper member 4D can be easily ensured.

Furthermore, in the present embodiment, the proximal portion 64 of the shaft portion 62 of the locking base 6 and the holding member 5 are located, at least in part, at the same location in the axial direction of the winding drum 3. In particular, the proximal portion 64 and the engagement teeth 52 are at the same axial location. Accordingly, the dimension of the seat belt retractor 1 in the axial direction of the winding drum 3 can be minimized, thereby allowing the seat belt retractor 1 to be downsized.

Furthermore, in the present embodiment, the holding member 5 serves as a drive wheel of the pretensioner 1C. This makes it possible to reduce the number of additional components required to construct the pretensioner 1C.

### Modifications

The present invention is not limited to the embodiment described above, and various modifications can be made without departing from the gist of the present invention.

For example, the impact energy absorbing member 4A is not limited to a torsion bar, and may be any component that absorbs impact energy in response to relative rotation between the winding drum 3 and the locking base 6. For example, the impact energy absorbing member 4A may be a wire that absorbs impact energy by being bent and deformed in response to relative rotation between the winding drum 3 and the locking base 6.

The pretensioner 1C may be omitted. In this case, the holding member 5 need not include the engagement teeth 52. The ring member 55 may be integrated with the holding member 5 and unable to rotate relative to the holding member 5.

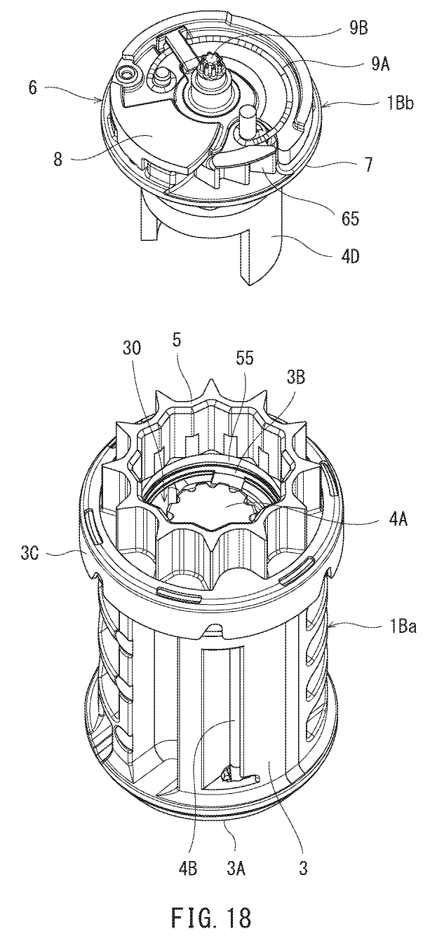

In the embodiment described above, when the winding drum unit 1B is assembled, the torsion bar serving as the impact energy absorbing member 4A is included in the second subassembly 1Bb. Alternatively, as illustrated in FIG. 18, the torsion bar may be included in the first subassembly 1Ba. In this case, the second subassembly 1Bb is joined onto the first subassembly 1Ba, thereby coupling the torsion bar to the locking base 6 and mounting the locking base 6 to the holding member 5. When the second subassembly 1Bb is joined onto the first subassembly 1Ba, the stopper member 4D is mounted at a proper location in the central hole 30 of the winding drum 3, and the torsion bar is mounted at a proper location in the recess 62a of the locking base 6.

In the example of FIG. 18, the torsion bar and the locking base 6 may be kept coupled together by pressing the coupling portion 42 of the torsion bar into the recess 62a of the shaft portion 62 of the locking base 6, instead of using the spring pin 40. In this case, the coupling portion 42 is configured to be fitted into the recess 62a in a plurality of fitting positions the number of which is equal to the number of possible mounting positions of the locking base 6 on the holding member 5 and which are orientations defined by rotation about the rotational axis of the winding drum 3.

### Conclusion

A first aspect of the present disclosure provides a seat belt retractor as a first mode of the disclosure, the seat belt retractor including: a housing including a pair of opposed side walls; a winding drum on which a webbing is wound, the winding drum being located between the pair of side walls and rotatable in a winding direction for winding of the webbing and in a pull-out direction for pull-out of the webbing, the winding drum including a central hole opening at least in a first axial direction that is one of opposite axial directions of the winding drum; an annular holding member located in the first axial direction relative to the winding drum and rotatable relative to the winding drum; a locking base mounted on the holding member, rotatable together with the holding member, and configured to be prevented from rotating in the pull-out direction in a vehicle emergency, the locking base including a main body portion located across the holding member from the winding drum in the first axial direction, and a shaft portion projecting from the main body portion into an interior of the holding member and including a male thread on an outer peripheral surface of a portion located toward a distal end of the shaft portion, the shaft portion being coaxial with the winding drum; an impact energy absorbing member including a first end and a second end, coupled to the winding drum at or near the first end and to the locking base at or near the second end, and configured to, under a normal state, connect the winding drum and the locking base such that the winding drum and the locking base are rotatable together, the impact energy absorbing member being further configured to, in case that a pull-out force applied to the webbing exceeds a predetermined level while rotation of the locking base in the pull-out direction is prevented, plastically deform to absorb impact energy while permitting relative rotation between the winding drum and the locking base; an impact energy absorbing wire received in a slot located in the winding drum, the slot having an opening facing in the first axial direction, the impact energy absorbing wire including a head portion protruding from the opening of the slot and attached to the holding member, the impact energy absorbing wire being configured to, during relative rotation between the winding drum and the locking base, be pulled out from the opening of the slot while plastically deforming to absorb impact energy; and a stopper member held in the central hole, unable to rotate relative to the winding drum, movable in the first axial direction and in a second axial direction opposite to the first axial direction, and screwed on to the male thread of the locking base, the stopper member being configured to define an allowable amount of relative rotation between the winding drum and the locking base during impact energy absorption by the impact energy absorbing member, wherein the locking base is mountable to the holding member in a plurality of mounting positions that are orientations defined by rotation about a rotational axis of the winding drum, and a dimension of an inner contour of the holding member, as viewed in the first axial direction, is greater than a dimension of an outer contour of the stopper member.

In the above configuration, the dimension of the inner contour of the holding member is greater than the dimension of the outer contour of the stopper member. Accordingly, after the holding member has been mounted on the winding drum, the stopper member can be inserted into the central hole in a direction from the holding member toward the winding drum. That is, a second subassembly including the locking base and the stopper member can be joined onto a first subassembly including the winding drum, the holding member, and the impact energy absorbing wire. The impact energy absorbing member may be included in either the first subassembly or the second subassembly. When joining a subassembly onto the winding drum, it is unnecessary to, as in the case of conventional seat belt retractors, mount the stopper member and the impact energy absorbing member at their respective proper locations while concurrently placing the elongated impact energy absorbing wire into the slot. The impact energy absorbing wire can be placed in the slot of the winding drum before the second subassembly is joined onto the first subassembly, and joining the second subassembly onto the first subassembly can be accomplished simply by mounting the stopper member and the impact energy absorbing member at their respective proper locations. Accordingly, the winding drum unit can be assembled more easily than conventional winding drum units. A location “at or near the first end” may correspond to a location closer to the first end than the second end. A location “at or near the second end” may correspond to a location closer to the second end than the first end.

In addition, the locking base is mountable to the holding member in a plurality of mounting positions that are orientations defined by rotation about the rotational axis of the winding drum. Accordingly, the pull-out amount of the webbing during impact energy absorption can be finely adjusted by changing the mounting position of the locking base on the holding member.

In a seat belt retractor according to a second mode based on the first mode, the stopper member may be insertable into the central hole at a plurality of mounting positions that are orientations defined by rotation at predetermined angular intervals, and the locking base may be mountable to the holding member at a plurality of mounting positions that are orientations defined by rotation at angular intervals smaller than the predetermined angular intervals. In this configuration, the pull-out amount of the webbing during impact energy absorption can be adjusted at large angular intervals by changing the mounting position of the stopper member on the winding drum, and can be adjusted at small angular intervals by changing the mounting position of the locking base on the holding member. Since it is unnecessary to provide a large number of mounting positions for the stopper member on the winding drum, sufficient mounting strength between the winding drum and the stopper member can be easily ensured.

In a seat belt retractor according to a third mode based on the first or second mode, the shaft portion of the locking base may include a proximal portion protruding radially outward beyond the male thread at a portion of the shaft portion from the male thread toward the main body portion of the locking base, the proximal portion being configured to be contacted by the stopper member to prevent the stopper member from moving in the axial direction of the winding drum, and the stopper member may contact the proximal portion in the interior of the holding member. In this configuration, the proximal portion of the shaft portion of the locking base and the holding member are located, at least in part, at the same location in the axial direction of the winding drum. Accordingly, the length of the seat belt retractor in the axial direction of the winding drum can be minimized, thereby allowing the seat belt retractor to be downsized.

A seat belt retractor according to a fourth mode based on any one of the first to third modes may further include a pretensioner configured to, in a vehicle emergency, rotate the holding member to rotate the winding drum in the winding direction via the locking base and the impact energy absorbing member. In this configuration, since the holding member serves as a drive wheel of the pretensioner, the number of additional components required to construct the pretensioner can be reduced.

In a seat belt retractor according to a fifth mode based on the fourth mode, the holding member may include engagement teeth on an outer periphery of the holding member, the pretensioner may include a movable member that moves during operation of the pretensioner, the movable member being configured to, while moving, engage with the engagement teeth to rotate the holding member, the shaft portion of the locking base may include a proximal portion protruding radially outward beyond the male thread at a portion of the shaft portion from the male thread toward the main body portion of the locking base, the proximal portion being configured to be contacted by the stopper member to prevent the stopper member from moving in the axial direction of the winding drum, and the stopper member may contact the proximal portion within a region where the engagement teeth exist in the axial direction of the winding drum. In this configuration, the proximal portion of the shaft portion of the locking base and the engagement teeth of the holding member are located at the same location in the axial direction of the winding drum. Accordingly, the length of the seat belt retractor in the axial direction of the winding drum can be minimized, thereby allowing the seat belt retractor to be downsized.

A second aspect of the present disclosure provides a method of producing a seat belt retractor as a sixth mode of the disclosure, the method including assembling a winding drum unit including a first subassembly and a second subassembly, wherein the first subassembly includes a winding drum, a holding member, and an impact energy absorbing wire, the second subassembly includes a locking base, a stopper member, and an impact energy absorbing member, and the assembling of the winding drum unit includes joining the second subassembly onto the first subassembly to couple the impact energy absorbing member to the winding drum and to mount the locking base to the holding member. With this method, the winding drum unit can be assembled more easily than with conventional methods.

A third aspect of the present disclosure provides a method of producing a seat belt retractor as a seventh mode of the disclosure, the method including assembling a winding drum unit including a first subassembly and a second subassembly, wherein the first subassembly includes a winding drum, an impact energy absorbing member, a holding member, and an impact energy absorbing wire, the second subassembly includes a locking base and a stopper member, and the assembling of the winding drum unit includes joining the second subassembly onto the first subassembly to couple the impact energy absorbing member to the locking base and to mount the locking base to the holding member. With this method, the winding drum unit can be assembled more easily than with conventional methods.

In a method according to an eighth mode based on the sixth or seventh mode, in the first subassembly, the holding member may be retained on the winding drum by an annular member fitted on an end of the winding drum. In this method, it is easy to handle the first subassembly since the holding member is retained on the winding drum by the annular member.

What is claimed is:

1. A seat belt retractor comprising:
a housing including a pair of opposed side walls;
a winding drum on which a webbing is wound, the winding drum being located between the pair of side walls and rotatable in a winding direction for winding of the webbing and in a pull-out direction for pull-out of the webbing, the winding drum including a central hole opening at least in a first axial direction that is one of opposite axial directions of the winding drum;
an annular holding member located in the first axial direction relative to the winding drum and rotatable relative to the winding drum;
a locking base mounted on the holding member, rotatable together with the holding member, and configured to be prevented from rotating in the pull-out direction in a vehicle emergency, the locking base including
a main body portion located across the holding member from the winding drum in the first axial direction, and
a shaft portion projecting from the main body portion into an interior of the holding member and including a male thread on an outer peripheral surface of a portion located toward a distal end of the shaft portion, the shaft portion being coaxial with the winding drum;
an impact energy absorbing member including a first end and a second end, coupled to the winding drum at or near the first end and to the locking base at or near the second end, and configured to, under a normal state, connect the winding drum and the locking base such that the winding drum and the locking base are rotatable together, the impact energy absorbing member being further configured to, in case that a pull-out force applied to the webbing exceeds a predetermined level while rotation of the locking base in the pull-out direction is prevented, plastically deform to absorb impact energy while permitting relative rotation between the winding drum and the locking base;
an impact energy absorbing wire received in a slot located in the winding drum, the slot having an opening facing in the first axial direction, the impact energy absorbing wire including a head portion protruding from the opening of the slot and attached to the holding member, the impact energy absorbing wire being configured to, during relative rotation between the winding drum and the locking base, be pulled out from the opening of the slot while plastically deforming to absorb impact energy; and
a stopper member held in the central hole, unable to rotate relative to the winding drum, movable in the first axial direction and in a second axial direction opposite to the first axial direction, and screwed on to the male thread of the locking base, the stopper member being configured to define an allowable amount of relative rotation between the winding drum and the locking base during impact energy absorption by the impact energy absorbing member, wherein
the locking base is mountable to the holding member in a plurality of mounting positions that are orientations defined by rotation about a rotational axis of the winding drum, and
a dimension of an inner contour of the holding member, as viewed in the first axial direction, is greater than a dimension of an outer contour of the stopper member.

2. The seat belt retractor according to claim 1, wherein
the stopper member is insertable into the central hole at a plurality of mounting positions that are orientations defined by rotation at predetermined angular intervals, and
the locking base is mountable to the holding member at a plurality of mounting positions that are orientations defined by rotation at angular intervals smaller than the predetermined angular intervals.

3. The seat belt retractor according to claim 1, wherein
the shaft portion of the locking base includes a proximal portion protruding radially outward beyond the male thread at a portion of the shaft portion from the male thread toward the main body portion of the locking base, the proximal portion being configured to be contacted by the stopper member to prevent the stopper member from moving in the axial direction of the winding drum, and
the stopper member contacts the proximal portion in the interior of the holding member.

4. The seat belt retractor according to claim 1, further comprising a pretensioner configured to, in a vehicle emergency, rotate the holding member to rotate the winding drum in the winding direction via the locking base and the impact energy absorbing member.

5. The seat belt retractor according to claim 4, wherein
the holding member includes engagement teeth on an outer periphery of the holding member,
the pretensioner includes a movable member that moves during operation of the pretensioner, the movable member being configured to, while moving, engage with the engagement teeth to rotate the holding member,
the shaft portion of the locking base includes a proximal portion protruding radially outward beyond the male thread at a portion of the shaft portion from the male thread toward the main body portion of the locking base, the proximal portion being configured to be contacted by the stopper member to prevent the stopper member from moving in the axial direction of the winding drum, and
the stopper member contacts the proximal portion within a region where the engagement teeth exist in the axial direction of the winding drum.

6. A method of producing a seat belt retractor, comprising assembling a winding drum unit including a first subassembly and a second subassembly, wherein
the first subassembly includes a winding drum, a holding member, and an impact energy absorbing wire,
the second subassembly includes a locking base, a stopper member, and an impact energy absorbing member, and
the assembling of the winding drum unit includes joining the second subassembly onto the first subassembly to couple the impact energy absorbing member to the winding drum and to mount the locking base to the holding member.

7. A method of producing a seat belt retractor, comprising assembling a winding drum unit including a first subassembly and a second subassembly, wherein
the first subassembly includes a winding drum, an impact energy absorbing member, a holding member, and an impact energy absorbing wire,
the second subassembly includes a locking base and a stopper member, and
the assembling of the winding drum unit includes joining the second subassembly onto the first subassembly to couple the impact energy absorbing member to the locking base and to mount the locking base to the holding member.

8. The method according to claim 6, wherein in the first subassembly, the holding member is retained on the winding drum by an annular member fitted on an end of the winding drum.

9. The method according to claim 7, wherein in the first subassembly, the holding member is retained on the winding drum by an annular member fitted on an end of the winding drum.
